(19) United States
(12) Patent Application Publication
(10) Pub. No.: US 2022/0245683 A1
(43) Pub. Date: Aug. 4, 2022

(54) SYSTEMS AND METHODS FOR GENERATING A VISUALIZED RECURRENCE SCHEDULE

(71) Applicant: salesforce.com, inc., San Francisco, CA (US)

(72) Inventors: Michael Smith, Pennington, CA (US); Radmila Askraba, Vancouver, British Columbia (CA); Mary Pustejovsky, Madison, WI (US); Eugene Reede Stockton, Forest Knolls, CA (US); Claire Rowlett, Washington, DC (US); Cheng-Yeh Andrew Yu, Chino Hills, CA (US)

(73) Assignee: salesforce.com, inc., San Francisco, CA (US)

(21) Appl. No.: 17/248,571

(22) Filed: Jan. 29, 2021

(51) Int. Cl. G06Q 30/02; G06Q 10/10; G06F 16/245

(52) U.S. Cl. CPC G06Q 30/0279; G06F 16/245; G06Q 10/1097

(57) ABSTRACT

Systems and methods for generating a visualized recurrence schedule for services that utilize recurring donations and operate on an instance of a web application. The system receives a query for recurring donations information for a donor in a donor database. In response to the query, the system generates and causes a display of a recurrence schedule using the donations information for the donor, the recurrence schedule comprising a plurality of installments, each installment having a date and an amount, The display is presented in accordance with a predetermined visualization scheme. The system can receive a user modification for an installment of the plurality of installments, to either (i) pause the amount or (ii) change the amount. The method regenerates the recurrence schedule and regenerates the display, to thereby display the recurrence schedule, as modified, on a display device in a client device.

### TECHNICAL FIELD

Embodiments of the subject matter described herein relate generally to database management systems, and more particularly, embodiments of the subject matter relate to generating a visualized recurrence schedule for services that utilize recurring donations.

### BACKGROUND

Some services that run on database management systems manage donations from donors. Donations can be one-time or cyclical. In some scenarios, a donor will arrange a donation of a set amount of money, on a pre-arranged cycle, such as ten dollars per month, on the first of the month; these are referred to herein as recurring donations. An administrator that is monitoring donations often wishes to view a schedule of forecasted donations for a donor (referred to herein as a recurrence schedule), to anticipate and plan for future financial status.

In some scenarios, a donor making a recurring donation may pause the donation or change the amount of the donation for one or more cycles. For example, the donor may pause the donations in November and December to use the money toward holiday purchases or reduce the amount of the donation during a season when the household is receiving less income due to a seasonal job. The administrator that is monitoring donations may wish to view a recurrence schedule of the donations for the donor that reflects any such pauses or changes in amount. In available services, to view these recurrence schedules, the administrator has the technical challenge of researching the donor's information and manually creating a table or chart to visualize the recurrence schedule for the donor.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a schedule visualization system for generating a visualized recurrence schedule according to some example implementations;

FIG. 2 is a flow diagram illustrating an exemplary process 200 steps for a schedule visualization method to generate a visualized recurrence schedule, according to some example implementations;

FIGS. 3-4 are flow diagrams providing more detailed process steps in support of FIG. 2, according to some example implementations;

FIGS. 5 and 6 depict exemplary web page graphical user interface (GUI) displays presenting a visualized recurrence schedule on a client device in the computing system of FIG. 1 as may be generated by the schedule visualization system of FIG. 1 according to some example implementations;

FIG. 7A is a block diagram illustrating an electronic device according to some example implementations.

FIG. 7B is a block diagram of a deployment environment according to some example implementations.

### DETAILED DESCRIPTION

The provided systems and methods provide a solution to the technical challenges described above in the form of the schedule visualization service. In some implementations, the schedule visualization service embodies a schedule visualization service; in other implementations, the schedule visualization service is incorporated into an existing web application or customer management service.

The below discussion references pausing or skipping an amount and changing an amount. As used herein, an example of pausing or skipping an amount includes a donor skipping the donations in November and December (i.e., setting them to zero) to use the money toward holiday purchases; and, an example of changing an amount includes a donor reducing the amount of the donation during a season when the household is receiving less income due to a seasonal job (e.g., June through August, the amount is $10 per month, whereas it is $30 per month for the remaining months).

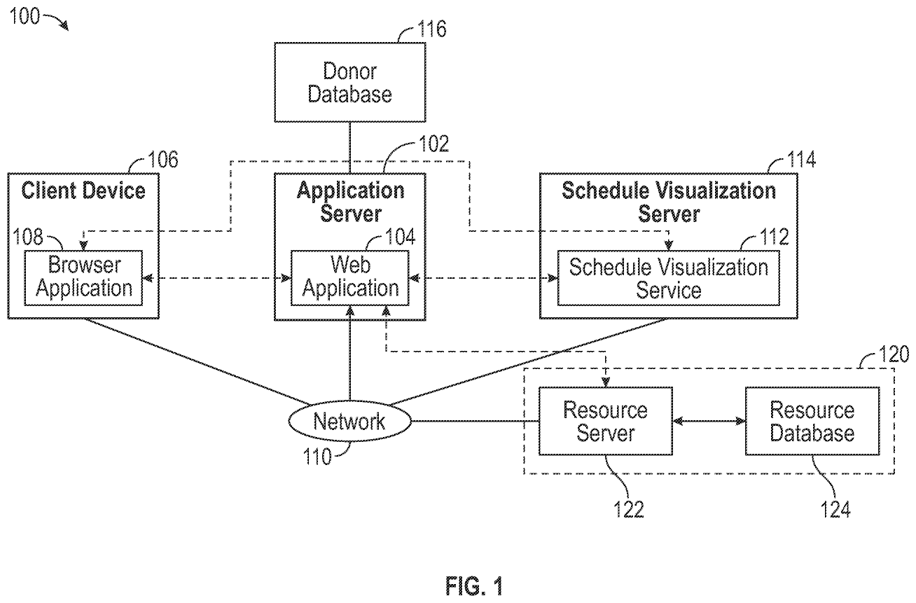

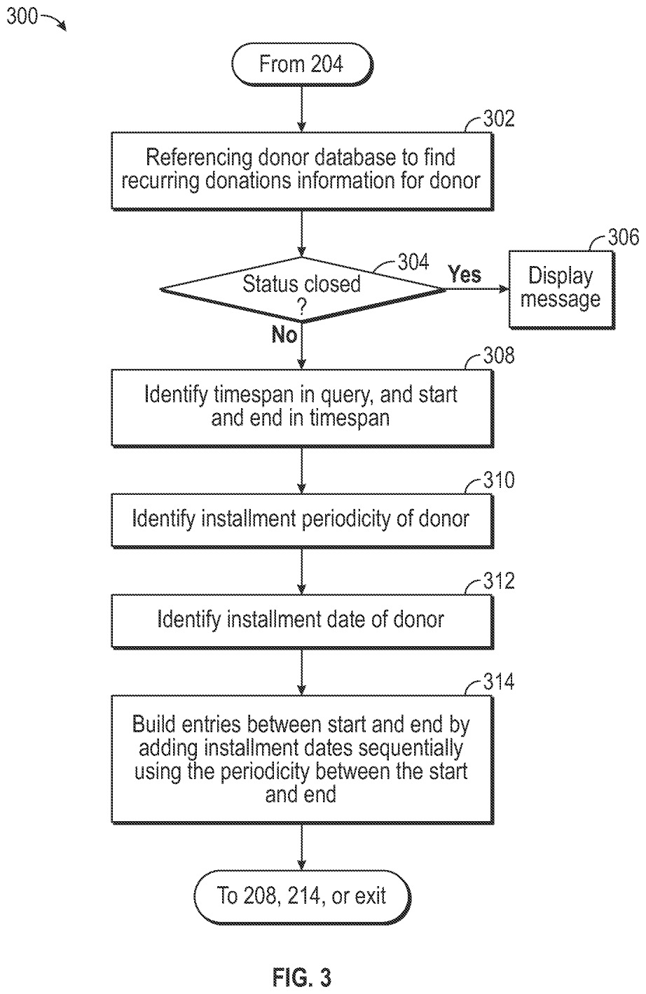

As described in greater detail below, in one or more implementations, a schedule visualization service references recurring donations information generally stored in a donor database (FIG. 1, database 116) and uses the recurring donations information for a donor to generate therefrom a recurrence schedule for the donor, the recurrence schedule comprising a plurality of installments, each installment having a date and an amount. The schedule visualization service can receive user modifications and modify the recurrence schedule to reflect the modifications. The user modifications generally include, on an installment of the plurality of installments, (i) skipping the amount or (ii) changing the amount. In some implementations, the user modifications include (iii) changing the recurrence schedule itself; for example, changing the day of month of the charge, or changing from everyone one month to every 2 months, or changing from Monthly to Weekly (these donor information features are referred to as the installment periodicity and the installment date, as is described in more detail in connection with FIG. 3, below). The recurrence schedule can be presented to and utilized by a user by displaying it in accordance with a predetermined visualization scheme. The predetermined visualization scheme imposes a graphical user interface (GUI) formatting and data presentation style, such as, for example, the organization of the applicable installment information into rows and columns that are consistent across multiple queries and multiple different donors. The recurrence schedules, once generated, can be stored, shared, and printed as a report. Due to the consistency provided by the recurrence schedule service, the recurrence schedules can be referenced by other Applications and Services.

FIG. 1 depicts an exemplary system 100 for schedule visualization that generates a visualized recurrence schedule over a network, such as, for example, a third-party system that securely maintains data or other information associated with users. It should be appreciated that FIG. 1 depicts a simplified representation of the system 100 for purposes of explanation and is not intended to be limiting.

The system 100 includes an application server 102 configurable to provide instances of a web application 104 within client applications 108 executed on client devices 106 communicatively coupled to the application server 102 via a communications network 110, such as the Internet or any sort or combination of wired and/or wireless computer network, a cellular network, a mobile broadband network, a radio network, or the like. In one or more implementations, the web application 104 is realized as a virtual application generated at run-time or on-demand. In one or more implementations, the web application 104 is a non-profit application designed specifically to support non-profit clients.

As described in greater detail below, the web application 104 may utilize a schedule visualization service 112 provided by a schedule visualization server 114 to facilitate a user of the client device 106 to search a donor database 116 and generate, for a donor, a visualized recurrence schedule.

The client device 106 generally represents an electronic device coupled to the network 110 that may be utilized by a user to access the web application 104 on the application server 102 and utilize the web application 104 to retrieve, view, and/or otherwise access data associated with the user that resides at a third-party computing system 120 via the network 110. In practice, the client device 106 can be realized as any sort of personal computer, mobile telephone, tablet or other network-enabled electronic device. Additional examples of client devices 106 include wearable devices, smart appliances, and vehicle-based systems or applications. In exemplary embodiments, the client device 106 includes a display device, such as a monitor, screen, or another conventional electronic display, capable of graphically presenting data and/or information provided by the web application 104 along with a user input device, such as a touchscreen, a touch panel, a mouse, a joystick, a directional pad, a motion sensor, or the like, capable of receiving input from the user of the client device 106. The illustrated client device 106 executes or otherwise supports a client application 108 that communicates with the web application 104 on the application server 102 using a networking protocol. In some implementations, the client application 108 is realized as a web browser or similar local client application executed by the client device 106 that contacts the application server 102 and/or the web application 104 using a networking protocol, such as the hypertext transport protocol (HTTP) or the like, to access or otherwise initiate an instance of the web application 104 being presented on the client device 106 (e.g., by or within the client application 108).

The application server 102 generally represents a server computing device, server computing system or another combination of processing logic, circuitry, hardware, and/or other components configured to support the web application 104 and related authorization processes, tasks, operations, and/or functions described herein. In this regard, the application server 102 generally includes a processing system, which may be implemented using any suitable processing system and/or device, such as, for example, one or more processors, central processing units (CPUs), controllers, microprocessors, microcontrollers, processing cores and/or other hardware computing resources configured to support the operation of the processing system described herein. The processing system may include or otherwise access a data storage element (or memory) capable of storing programming instructions for execution by the processing system, that, when read and executed, are configurable cause processing system to create, generate, or otherwise facilitate an application platform that generates or otherwise provides instances of a web application 104 at run-time (or “on-demand”) based at least in part upon code and other data that is stored or otherwise maintained by the memory, a database, or another location on the network 110 and support the authorization processes described herein. Depending on the embodiment, the memory may be realized as a random access memory (RAM), read only memory (ROM), flash memory, magnetic or optical mass storage, or any other suitable non-transitory short or long term data storage or other computer-readable media, and/or any suitable combination thereof.

Similar to the application server 102, the schedule visualization server 114 generally represents a server computing device, server computing system or another combination of processing logic, circuitry, hardware, and/or other components configured to automatically generate and assign unique human-readable aliases to web applications and support the related authorization processes, tasks, operations, and/or functions described herein. In this regard, the schedule visualization server 114 generally includes a processing system, which may be implemented using any suitable processing system and/or device, such as, for example, one or more processors, central processing units (CPUs), controllers, microprocessors, microcontrollers, processing cores and/or other hardware computing resources configured to support the operation of the processing system described herein. The processing system may include or otherwise access a data storage element (or memory) capable of storing programming instructions for execution by the processing system, that, when read and executed, are configurable cause processing system to create, generate, or otherwise facilitate the schedule visualization service 112 that supports the schedule visualization processes described herein based at least in part upon code and other data that is stored or otherwise maintained by the memory and/or the donor database 116. In various implementations, the visualization server 114 is integrated within the application server 102, such that the schedule visualization service is an enhancement to the web application 104.

In the illustrated implementation depicted in FIG. 1, the third-party computing system 120 includes a resource server 122 communicatively coupled to the network 110 to support access to individual users' data, information, or other protected resources maintained in a resource database 124. In various implementations, the donor database 116 resides in the resource database 124. In this regard, the resource server 122 generally represents a server computing device, server computing system or another combination of processing logic, circuitry, hardware, and/or other components configured to support remote access to data maintained in the resource database 124 via the network 110. For example, the resource database 124 may maintain, on behalf of a user (or resource owner), data records entered or created by the user, files, objects or other records uploaded by the user, and/or files, objects or other records generated by one or more computing processes (e.g., by the resource server 122 based on user input or other records or files stored in the database 124).

In practice, the third-party computing system 120 is physically and logically distinct from the application server 102 and the schedule visualization server 114. In exemplary implementations, the third-party computing system 120 resides at a different physical location than the application server 102 and is owned, controlled, or otherwise operated by a third-party different from the different parties that own, control and/or operate the application server 102. In some implementations, the schedule visualization server 114 is affiliated with the same party that owns, controls and/or operates the third-party computing system 120. That said, in various implementations, the schedule visualization server 114 resides at a different physical location than the third-party computing system 120 and/or the schedule visualization server 114 is owned, controlled, or otherwise operated by another party that is independent and different from the operator of the third-party computing system 120 and the developer operator of the application server 102.

In one or more embodiments, the third-party computing system 120 is realized as an on-demand multi-tenant database system that is capable of dynamically creating and supporting virtual applications based upon data from a common resource database 124 that is shared between multiple tenants, which may alternatively be referred to herein as a multi-tenant database. Data and services generated by the virtual applications may be provided via the network 110 to any number of client devices, as desired. Each virtual application may be suitably generated at run-time (or on-demand) using a common application platform that securely provides access to the data in the database 124 for each of the various tenants subscribing to the multi-tenant system. In accordance with one non-limiting example, the third-party computing system 120 is implemented in the form of an on-demand multi-tenant customer relationship management (CRM) system that can support any number of authenticated users of multiple tenants. In this regard, one or more implementations of the third-party computing system 120 support one or more application program interfaces (APIs) at the resource server 122 that allow other web applications 104 and/or application servers 102 on the network 110 that have been authorized by the schedule visualization service 112 to access and perform operations with respect to individual tenant's data maintained in the database 124 that would otherwise be secured and inaccessible to unauthorized third parties.

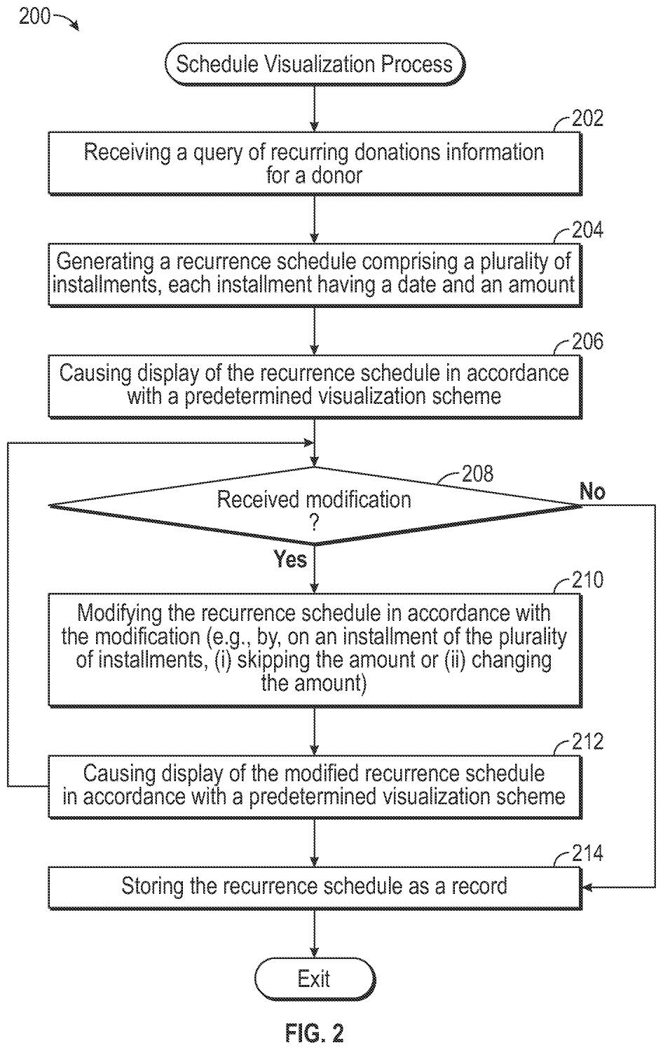

FIG. 2 depicts process 200 steps for an exemplary schedule visualization method that may be implemented or otherwise performed by a computing system to provide visualized recurrence schedules and perform additional tasks, functions, and/or operations described herein. For illustrative purposes, the following description may refer to elements mentioned above in connection with FIG. 1. In this regard, while portions of the schedule visualization process 200 may be performed by different elements of the computing system 100, for purposes of explanation, the subject matter is described herein in the context of the schedule visualization process 200 being primarily performed by the schedule visualization service 112 and the schedule visualization server 114. It should be appreciated that the schedule visualization process 200 may include any number of additional or alternative tasks, the tasks need not be performed in the illustrated order and/or the tasks may be performed concurrently, and/or the schedule visualization process 200 may be incorporated into a more comprehensive procedure or process having additional functionality not described in detail herein. Moreover, one or more of the tasks shown and described in the context of FIG. 2 could be omitted from a practical embodiment of the schedule visualization process 200 as long as the intended overall functionality remains intact.

The schedule visualization process 200 initializes or otherwise begins by receiving, by the schedule visualization service 114, a request or query (at 202), via a user input interface on a client device 106, for recurring donations information for a donor in the donor database 116. Specifically, the query is received via a user input interface on a client device 106 running an instance of the web application 104, which has access to the donor database 116. In various implementations, the user is an administrator and generally not the same person as the donor. The administrator may be an administrator of the web application 104 and may have had to clear various authentication protocols before starting the schedule visualization process 200. The request for recurring donations information for the donor generally includes a timespan. In some implementations, the requested timespan is a duration of time from a start date to an end date (e.g., the installments from today until the end of the year). In some implementations, the request for recurring donations information for the donor may be requested for timespan provided as a start date and number of cycles (e.g., the next ten installments, starting today). As mentioned, the system 100 accesses the donor database 116 to obtain the raw donor donation information.

A recurrence schedule is generated for the requested donor at 204. The recurrence schedule may comprise a plurality of installments, each installment having a date and an amount. At 206, the system 100 causes a graphical user interface (GUI) display of the recurrence schedule on a display device in the client device 106, the GUI display being in accordance with a predetermined visualization scheme, responsive to the query. The GUI display may include one or more GUI panels or windows, and each panel or window may include one or multiple GUI elements. The GUI display includes at least the visualized recurrence schedule, which may be included with, or displayed as, a distinguishable GUI panel.

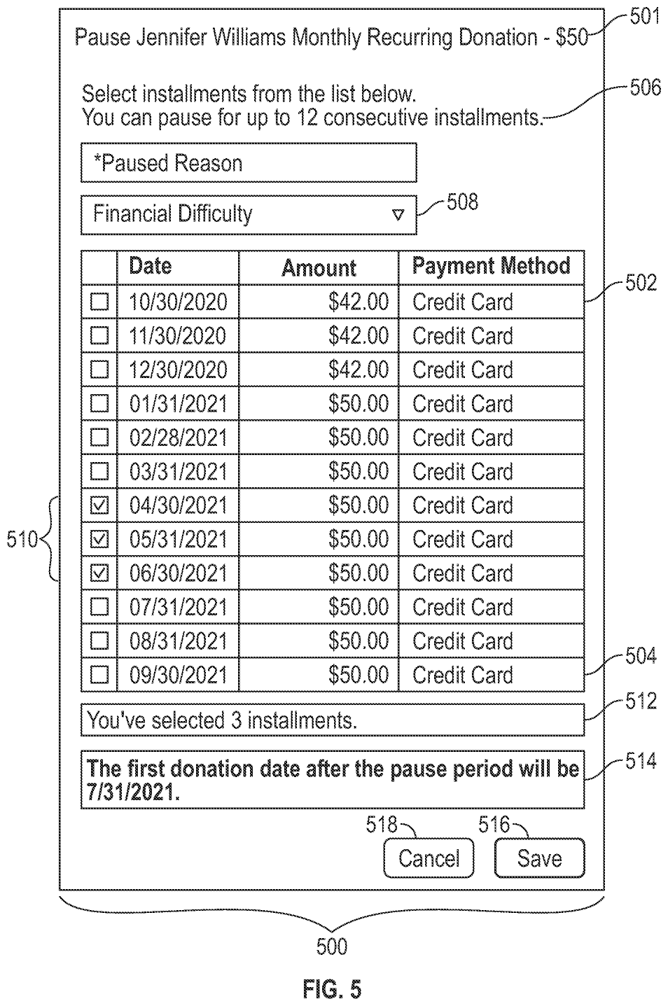

In order to perform process step 206, the system 100 references a preprogrammed visualization scheme that may be stored in memory with the schedule visualization program, in the schedule visualization server 114. The preprogrammed visualization scheme defines how the recurrence schedule for the donor is constructed, populated and displayed as a graphical user interface (GUI) display having a plurality of GUI elements; this includes data organization and graphical formatting/visualization techniques. In some implementations, and as described in connection with FIG. 5, the preprogrammed visualization scheme further includes rules for displaying various text boxes and prompts for additional user action that the system 100 can respond to.

Subsequent to causing the GUI display of the recurrence schedule, a user modification to the recurrence schedule may be received, via a user selection of a GUI element on the GUI display, the user modification being to, for an installment of the plurality of installments, (i) pause the amount or (ii) change the amount; or, for the donor, (iii) change the installment periodicity or the installment date in the donor information.

At 208, if no user modifications have been received for this donor in this timespan, the system 100 may move to storing the recurrence schedule as a record at 214 or may skip the storing step and end.

If, at 208, a user modification has been received, the process moves to 210 to modify the recurrence schedule in accordance with, and responsive to, the user modification. In implementations in which the user modification is, for the donor, a change the installment periodicity or the installment date, the output from 314 is a recurrence schedule regenerated accordingly. In some implementations, more than one user modification is received at 208, in which case, the installment is a first installment of the plurality of installments; and, the modification on the first installment is a first modification of a plurality of modifications on the plurality of installments. When multiple modifications are received, the system 100 cycles through 208 to 210 to 212 after each modification, until all modifications have been implemented.

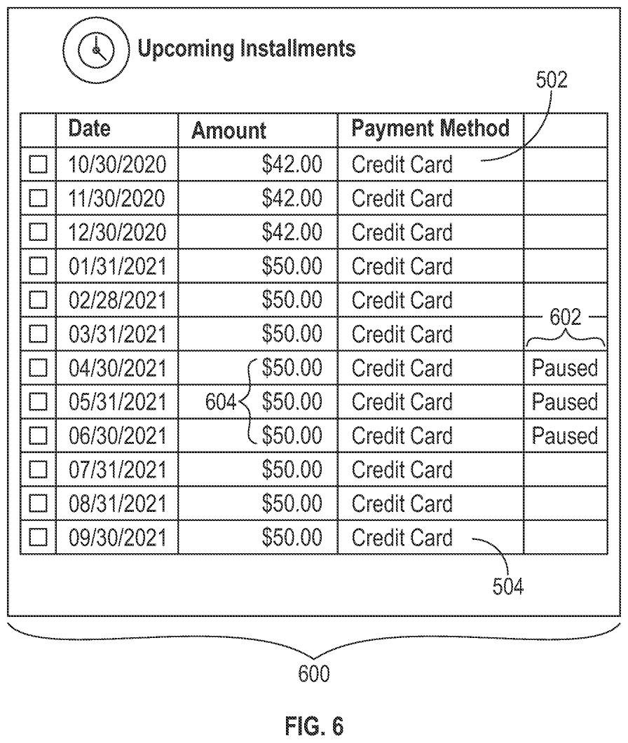

A modification received at 208 triggers not only the modification of the recurrence schedule at 210 but also a regeneration of the GUI display of the recurrence schedule, such that it is displayed, as modified, at 212, in accordance with the predetermined visualization scheme, as described above. As illustrated in FIG. 6, the predetermined visualization scheme includes visualization techniques to visually distinguish the modified installments from remaining installments. Examples of visualization techniques include highlighting installment rows, placing message alerts next to installments, enclosing affected installment rows in boxes with various border themes, and changing the color or font of text and numbers displayed in the installment rows.

After 212, responsive to a user request, the system 100 may, at 214, store the recurrence schedule as a record. The recurrence schedule may be stored in the donor database 116, or in the resource database. After 214, the process 200 may end, or the user may begin again with another donor query at 202.

In FIG. 3, an exemplary way to implement process step 204 is detailed. At 202, the query for recurring donations information for the donor is received. In various implementations, the query includes a timespan. As mentioned, the timespan may be defined by a start date (“start”) and an end date (“end”), or as a start and a number (of installments). Therefore, in various implementations, the input to process step 204 includes a donor name and a timespan. At 302, the donor database is referenced to find recurring donations information for the donor. Recurring donations information may further include details about the donor payments, such as, a type of payment (e.g., automatic bank withdrawal or credit card), and a commencement date. At 304, the system 100 checks to assure that the donor status is still open, meaning that the donor is still actively donating. If the donor status is not active (closed) at 304, the system 100 may cause the GUI display to present an alphanumeric message informing the user that the donor status is closed.

If the donor status is active, at 308, the system 100 identifies the start and the end from the timespan included in the query. At 310 and 312, the system parses the donor information to identify an installment periodicity of the donor at 310 (for example, every two weeks, or once a month, or once a year), an installment date of the donor (for example, the first of the month, or the 15^{th} of the month), and an installment amount of the donor. Having identified the installment date, installment periodicity, installment amount, and the start and end, the system can, at 314, build the entries between the start and end by determining the first installment date on or after the start and then using the periodicity and installment date to add additional entries. The installment amounts are included in each installment entry. The output from 314 is the initial recurrence schedule, in a form of raw data or datafile.

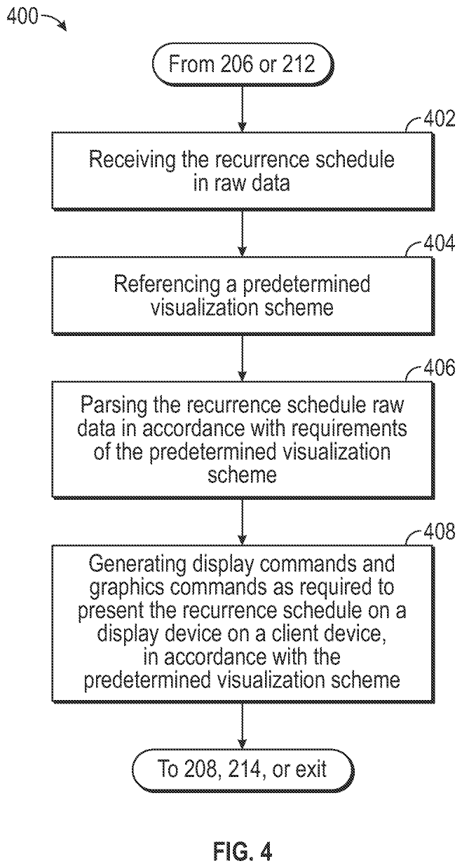

In FIG. 4, an exemplary way to implement process step 206 and process step 212 is detailed. At 402, the recurrence schedule, as raw data or the datafile, is received. The raw data may be the same raw data that was initially generated at 204, or it may be modified raw data, generated by step 210. At 404, the system 100 references the predetermined visualization scheme, which, as mentioned, is a set of rules embodied in code, for parsing and organizing the raw data recurrence schedule. At 406, the system 100 parses the raw data in accordance with the predetermined visualization scheme, and at 408, the system 100 generates display and graphics commands as required to present the recurrence schedule on a display device on a client device 106. The output from 206 is understood to include the raw data as well as the described graphics and display commands. As may be appreciated, the predetermined visualization scheme includes rules for displaying paused/skipped installments and for displaying modified installments, and when they are included in the raw data, the relevant rules are applied to distinguish those installments from the others (see, for example, FIG. 5). After 408, the process proceeds to 208 or 214, depending on the previous step, or exits.

The illustration in FIG. 5 depicts an exemplary GUI display 500 of a recurrence schedule, as may be generated by the process 200 at 206. User information field 501 identifies the donor and some additional information (in the example, the user is Jennifer Williams and her donations are currently a monthly recurring donation of $50). The GUI display is a visualized recurrence schedule; in the example, the visualized recurrence schedule formats the installment entries are arranged in a list or tabular format. The start 502 is the entry dated Oct. 30, 2020 and the end 504 is the entry dated Sep. 30, 2021. It's clear from viewing the entry dates in the display 500 that the periodicity is the 30^{th} of the month in amounts of $24 for the year 2020, and changes to a periodicity of the last day of the month, in amounts of $50 in the year 2021.

The system 100 causes the graphical user interface (GUI) display of the recurrence schedule to further prompt the user to select between pause and change functionality. In FIG. 5, the user information field 501 includes a text field for displaying when the user has made a modification request; in this example, it shows a request for a pause. In some implementations, the user can edit the word “pause” to the word “change” to put the system 100 in a change functionality. In other implementations, the GUI display includes GUI buttons to prompt the user to select pause or change functionality. Responsive to the user's selection of “pause” or “change” (or the equivalents), the system 100 provides a GUI element, prompt 506, for the user to select installments from the list. Another GUI element 508 scrolls for entering a paused reason; “financial difficulty” is selected. At 510, the user modification is received, and in the example, the entries for Apr. 30, 2021, May 31, 2021, and Jun. 30, 2021 have been selected for the pause. Responsive to the user selections and modifications, the system 100 displays one or more status updates, for example, at 512, informing the user that 3 installments have been selected, and at 514, informing the user that the first donation date after the pause will be Jul. 31, 2021. The user may save the modifications at GUI element 516 or cancel the modifications at GUI element 518.

The illustration in FIG. 6 depicts an exemplary display 600 of a recurrence schedule, as may be generated in response to receiving the modifications shown in FIG. 5, as may be provided by the process 200 at 212. At 602, a visualization technique is implemented to distinguish the modifications on the display 600. In the depicted implementation, a column 602 is dedicated to showing the user modifications with an alphanumeric message “pause”. Additionally, the installment rows have been highlighted in a color different from the remaining installment rows. In other implementations, different visualization techniques may be applied. Note that at 604, the donor amount has not changed. In other embodiments, at 604 the amount may be shown as $0. Regardless of how the paused installments are displayed, those with skill in the art will recognize that the output from the schedule visualization service can be used to forecast a total amount received from the donor during the timespan.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions) that may embody an algorithm or rules. Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a processor to perform operations when the instructions are executed by the processor. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

As mentioned, the term “user” refers to an entity (e.g., an individual person) that uses an electronic device. Software and/or services may use credentials to distinguish different accounts associated with the same and/or different users. Users can have one or more roles, and the software may enable distinctly different operating capabilities for a user, based on the user's role. Examples of roles that a user may have include an administrator, a programmer/developer, and an end user. As an administrator, a user typically uses electronic devices to administer them for other users, and thus an administrator often works directly and/or indirectly with server devices and client devices.

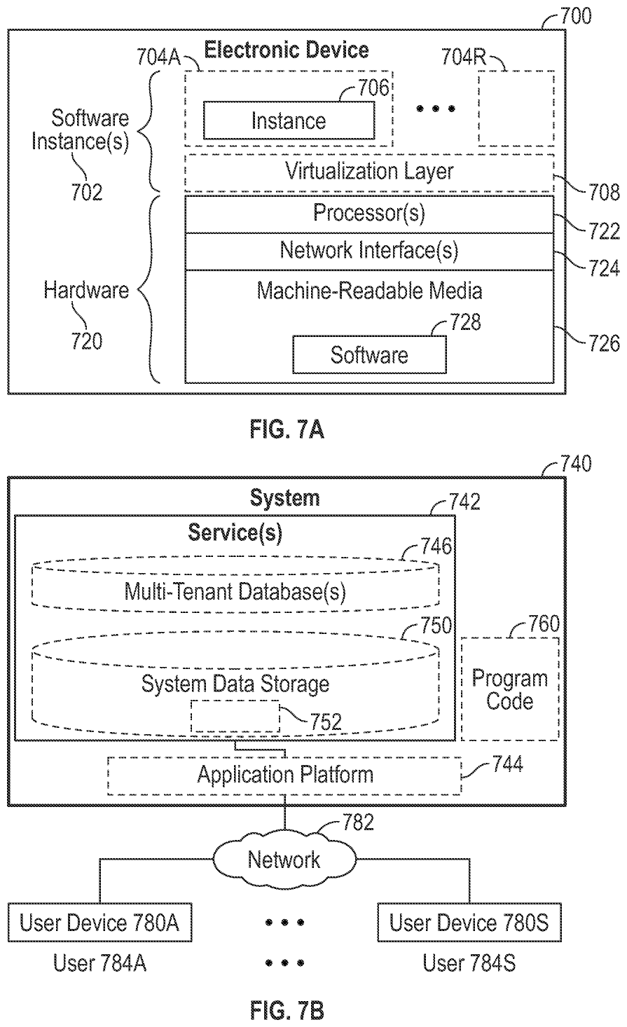

FIG. 7A is a block diagram illustrating an electronic device 700 according to some example implementations. FIG. 7A includes hardware 720 comprising a set of one or more processor(s) 722, a set of one or more network interfaces 724 (wireless and/or wired), and machine-readable media 726 having stored therein software 728 (which includes instructions executable by the set of one or more processor(s) 722). The machine-readable media 326 may include non-transitory and/or transitory machine-readable media. Each of the previously described clients and the schedule visualization service may be implemented in one or more electronic devices 700. In one implementation: 1) each of the clients is implemented in a separate one of the electronic devices 700 (e.g., in end user devices where the software 728 represents the software to implement clients to interface directly and/or indirectly with the schedule visualization service (e.g., software 728 represents a web browser, a native client, a portal, a command-line interface, and/or an application programming interface (API) based upon protocols such as Simple Object Access Protocol (SOAP), Representational State Transfer (REST), etc.)); 2) the schedule visualization service is implemented in a separate set of one or more of the electronic devices 700 (e.g., a set of one or more server devices where the software 728 represents the software to implement the schedule visualization service); and 3) in operation, the electronic devices implementing the clients and the schedule visualization service would be communicatively coupled (e.g., by a network) and would establish between them (or through one or more other layers and/or or other services) connections for submitting queries and edits for recurring donations information for a donor to the schedule visualization service and returning a recurrence schedule formatted for display in accordance with a predetermined visualization scheme to the clients. Other configurations of electronic devices may be used in other implementations (e.g., an implementation in which the client and the schedule visualization service are implemented on a single one of electronic device 700).

During operation, an instance of the software 728 (illustrated as instance 706 and referred to as a software instance; and in the more specific case of an application, as an application instance) is executed. In electronic devices that use compute virtualization, the set of one or more processor(s) 722 typically execute software to instantiate a virtualization layer 708 and one or more software container(s) 704A-304R (e.g., with operating system-level virtualization, the virtualization layer 708 may represent a container engine (such as Docker Engine by Docker, Inc. or rkt in Container Linux by Red Hat, Inc.) running on top of (or integrated into) an operating system, and it allows for the creation of multiple software containers 704A-304R (representing separate user space instances and also called virtualization engines, virtual private servers, or jails) that may each be used to execute a set of one or more applications; with full virtualization, the virtualization layer 708 represents a hypervisor (sometimes referred to as a virtual machine monitor (VMM)) or a hypervisor executing on top of a host operating system, and the software containers 704A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 728 is executed within the software container 704A on the virtualization layer 708. In electronic devices where compute virtualization is not used, the instance 706 on top of a host operating system is executed on the “bare metal” electronic device 700. The instantiation of the instance 706, as well as the virtualization layer 708 and software containers 704A-304R if implemented, are collectively referred to as software instance(s) 702.

Alternative implementations of an electronic device may have numerous variations from that described above. For example, customized hardware and/or accelerators might also be used in an electronic device.

FIG. 7B is a block diagram of a deployment environment according to some example implementations. A system 740 includes hardware (e.g., a set of one or more server devices) and software to provide service(s) 742, including schedule visualization service. In some implementations the system 740 is in one or more datacenter(s). These datacenter(s) may be: 1) first party datacenter(s), which are datacenter(s) owned and/or operated by the same entity that provides and/or operates some or all of the software that provides the service(s) 742; and/or 2) third-party datacenter(s), which are datacenter(s) owned and/or operated by one or more different entities than the entity that provides the service(s) 742 (e.g., the different entities may host some or all of the software provided and/or operated by the entity that provides the service(s) 742). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 740 is coupled to user devices 780A-380S over a network 782. The service(s) 742 may be on-demand services that are made available to one or more of the users 784A-384S working for one or more entities other than the entity which owns and/or operates the on-demand services (those users sometimes referred to as outside users) so that those entities need not be concerned with building and/or maintaining a system, but instead may make use of the service(s) 742 when needed (e.g., when needed by the users 784A-384S). The service(s) 742 may communicate with each other and/or with one or more of the user devices 780A-380S via one or more APIs (e.g., a REST API). In some implementations, the user devices 780A-380S are operated by users 784A-384S, and each may be operated as a client device and/or a server device. In some implementations, one or more of the user devices 780A-380S are separate ones of the electronic device 700 or include one or more features of the electronic device 700.

In some implementations, the system 740 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 740 is a multi-tenant cloud computing architecture supporting multiple services, such as one or more of the following types of services: Customer relationship management (CRM), including Non-Profit donor management; Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 740 may include an application platform 744 that enables PAAS for creating, managing, and executing one or more applications developed by the provider of the application platform 744, users accessing the system 740 via one or more of user devices 780A-380S, or third-party application developers accessing the system 740 via one or more of user devices 780A-380S.

In some implementations, one or more of the service(s) 742 may use one or more multi-tenant databases 746, as well as system data storage 750 for system data 752 accessible to system 740. In certain implementations, the system 740 includes a set of one or more servers that are running on server electronic devices and that are configured to handle requests for any authorized user associated with any tenant (there is no server affinity for a user and/or tenant to a specific server). The user devices 780A-380S communicate with the server(s) of system 740 to request and update tenant-level data and system-level data hosted by system 740, and in response the system 740 (e.g., one or more servers in system 740) automatically may generate one or more Structured Query Language (SQL) statements (e.g., one or more SQL queries) that are designed to access the desired information from the multi-tenant database(s) 746 and/or system data storage 750.

In some implementations, the service(s) 742 are implemented using virtual applications dynamically created at run time responsive to queries from the user devices 780A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 760 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 744 includes an application setup mechanism that supports application developers' creation and management of applications, which may be saved as metadata by save routines. Invocations to such applications, including the Schedule visualization service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 782 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 740 and the user devices 780A-380S.

Each user device 780A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 740. For example, the user interface device can be used to access data and applications hosted by system 740, and to perform searches on stored data, and otherwise allow one or more of users 784A-384S to interact with various GUI pages that may be presented to the one or more of users 784A-384S. User devices 780A-380S might communicate with system 740 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 780A-380S might include an HTTP client, commonly referred to as a “browser,” for sending and receiving HTTP messages to and from server(s) of system 740, thus allowing users 784A-384S of the user devices 780A-380S to access, process and view information, pages and applications available to it from system 740 over network 782.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

1. A method for schedule visualization for a web application having an associated donor database, the method comprising:
receiving a query for recurring donations information for a donor in the donor database, the query received via a user input interface on a client device running an instance of the web application;
in response to the query, generating a recurrence schedule using the donations information for the donor, the recurrence schedule comprising a plurality of installments, each installment having a date and an amount;
causing display of the recurrence schedule on a display device in the client device, the display being in accordance with a predetermined visualization scheme, responsive to the query; and
storing a record of the recurrence schedule for the donor.

2. The method of claim 1, further comprising:
subsequent to causing the display of the recurrence schedule,
receiving a user modification to the recurrence schedule, via a user selection of a graphical user interface (GUI) element on the display;
modifying the recurrence schedule in accordance with the user modification; and
responsive to the user modification, regenerating the display, to thereby display the recurrence schedule, as modified, on the display device in the client device, the display being in accordance with the predetermined visualization scheme.

3. The method of claim 1, further comprising:
causing the display of the recurrence schedule to include a prompt for the user to select a pause or a change functionality.

4. The method of claim 2, wherein the user modification is, for an installment of the plurality of installments, one of: (i) pause the amount and (ii) change the amount.

5. The method of claim 3, wherein the GUI display has the plurality of installments arranged in a list, and the method further comprising, responsive to receiving a user's selection of the pause or the change functionality, providing a GUI element to prompt the user to select installments from the list.

6. The method of claim 5, wherein receiving a user modification to the recurrence schedule further comprises:
receiving a user's selection of an installment from the list; and
responsive to receiving the user's selection of an installment from the list,
modifying the user's selected installment on the recurrence schedule in accordance with the user's selection of the pause or the change functionality.

7. The method of claim 1, wherein causing the display of the recurrence schedule on a display device in the client device further comprises:
parsing recurrence schedule data in accordance with the predetermined visualization scheme; and
generating display graphics commands to cause the display device on the client device to present the recurrence schedule in accordance with the predetermined visualization scheme.

8. The method of claim 7, wherein the predetermined visualization scheme includes visualization techniques to distinguish modified installments from remaining installments.

9. The method of claim 8, wherein the predetermined visualization scheme causes the display to present an alphanumeric message for paused installments.

10. The method of claim 1 wherein the installment of the plurality of installments is a first installment, and the user modification is a first modification, and the method further comprising:
subsequent to regenerating the display, to thereby display the recurrence schedule, as modified by the first modification,
receiving a second modification for a second installment of the plurality of installments;
modifying the recurrence schedule in accordance with the second modification; and
responsive to the second modification, regenerating the display, to thereby display the recurrence schedule, as modified by the second modification.

11. A non-transitory machine-readable storage medium that stores instructions executable by at least one processor, the instructions configurable to cause the at least one processor to perform operations comprising:
receiving a query for recurring donations information for a donor in the donor database, the query received via a user input interface on a client device running an instance of the web application;
in response to the query, generating a recurrence schedule using the donations information for the donor, the recurrence schedule comprising a plurality of installments, each installment having a date and an amount;
causing a display of the recurrence schedule on a display device in the client device, the display being in accordance with a predetermined visualization scheme, responsive to the query; and
storing a record of the recurrence schedule for the donor.

12. The non-transitory machine-readable storage medium of claim 11, wherein the instructions are configurable to cause the at least one processor to further perform operations comprising:
subsequent to causing the display of the recurrence schedule,
receiving a user modification to the recurrence schedule, via a user selection of a GUI element on the display;
modifying the recurrence schedule in accordance with the user modification; and
responsive to the user modification, regenerating the display, to thereby display the recurrence schedule, as modified, on the display device in the client device, in accordance with the predetermined visualization scheme.

13. (canceled)

14. The non-transitory machine-readable storage medium of claim 12, wherein the instructions are configurable to cause the at least one processor to further cause the display to arrange the plurality of installments in a list, and responsive to receiving a user's selection of the pause or the change functionality, providing a GUI element to prompt the user to select installments from the list.

15. The non-transitory machine-readable storage medium of claim 14, wherein the instructions are configurable to cause the at least one processor to further perform operations comprising:
receiving a user's selection of an installment from the list; and
responsive to receiving the user's selection of an installment from the list,
modifying the user's selected installment on the recurrence schedule in accordance with the user's selection of the pause or the change functionality.

16. The non-transitory machine-readable storage medium of claim 14, wherein the instructions are configurable to cause the at least one processor to further perform operations comprising:
parsing recurrence schedule data in accordance with the predetermined visualization scheme; and
generating display graphics commands to cause the display device on the client device to present the recurrence schedule in accordance with the predetermined visualization scheme.

17. The non-transitory machine-readable storage medium of claim 14, wherein the instructions are configurable to cause the at least one processor to generate display commands using visualization techniques to distinguish modified installments from remaining installments.

18. The non-transitory machine-readable storage medium of claim 14, wherein the instructions are configurable to cause the at least one processor to cause the display to present an alphanumeric message for paused installments.

19. The non-transitory machine-readable storage medium of claim 14, wherein the instructions are configurable to cause the at least one processor to, subsequent to regenerating the display, perform the operations comprising:
receiving a second modification for a second installment of the plurality of installments;
modifying the recurrence schedule in accordance with the second modification; and
responsive to the second modification, regenerating the GUI display, to thereby display the recurrence schedule, as modified by the second modification.

20. An apparatus comprising:
a processor; and
a non-transitory machine-readable storage medium that stores instructions executable by the processor, the instructions configurable to cause the processor to perform operations comprising:
receiving a query for recurring donations information for a donor in the donor database, the query received via a user input interface on a client device running an instance of the web application;
in response to the query, generating a recurrence schedule using the donations information for the donor, the recurrence schedule comprising a plurality of installments, each installment having a date and an amount;
causing a display of the recurrence schedule on a display device in the client device, the display being in accordance with a predetermined visualization scheme, responsive to the query;
subsequent to causing the display of the recurrence schedule,
receiving a user modification to the recurrence schedule, via a user selection of a GUI element on the display, the user modification being to, for an installment of the plurality of installments, (i) pause the amount or (ii) change the amount;
modifying the recurrence schedule in accordance with the modification; and
responsive to the modification, regenerating the display, to thereby display the recurrence schedule, as modified, on the display device in the client device, in accordance with the predetermined visualization scheme.

21. The apparatus of claim 19, wherein the instructions, if executed by the processor, are further configurable to cause the apparatus to perform operations comprising:
parsing recurrence schedule data in accordance with the predetermined visualization scheme; and
generating display graphics commands to cause the display device on the client device to present the recurrence schedule in accordance with the predetermined visualization scheme.
